(19) United States
(12) Patent Application Publication
(10) Pub. No.: US 2005/0220569 A1
(43) Pub. Date: Oct. 6, 2005

(54) Latching quick-connect connector

(75) Inventor: Joseph Ernest Dryer, Houston, TX (US)

Correspondence Address: Joseph E. Dryer, 10307 Sugar Hill Drive, Houston, TX, 77042, US

(73) Assignee: Joseph E. Dryer, Houston, TX (US)

(21) Appl. No.: 11/096,657

(22) Filed: Mar. 31, 2005

Related U.S. Application Data
(60) Provisional application No. 60/558,600, filed on Apr. 1, 2004.

(51) Int. Cl. F16B 25/00

(52) U.S. Cl. 411/553

(57) ABSTRACT

A method is presented to allow a quick, positive attachment of a fastener to a module body. The module body and the fastener each have interrupted screw sections to connect with a partial turn. A latching mechanism, such as a pawl and cog arrangement, can provide a positive lock when the interrupted screw threads are fully engaged. A mechanism such as tab lever can be used to disengage the positive lock to easily remove the module. The controlled traverse over a known thread pitch allows the use of a compressible face on the fastener with a fixed compression and a repeatable, tight connection.

### BACKGROUND OF THE INVENTION

1. Field of the Invention

This invention generally relates to a fastener. More particularly the invention relates to a quick-mount locking system for rapid and secure joining of two bodies.

2. Description of the Related Art

There are many requirements for a rapid and secure joining of a fastener to the body to be fastened. One area of such requirement is the attachment of component modules to a panel. The following discussion emphasizes that requirement but the invention is a more general method of the quick and secure fastening of devices with many broad applications outside this particular application described in detail.

Traditionally, components such as speakers, lights, and piezoelectric elements that are to be panel-mounted are enclosed in a module with a decorative head in front of the panel and a body inserted through the panel and secured by a threaded fastener. The use of the threaded fastener has several disadvantages. In large volume manufacture the time involved in screwing the nut is undesirable. The clamping force between the head and the fastener is determined by the tightening of the threaded fastener and can be a production variable. In addition, conditions like vibration can work the threaded fastener loose. Lock washers cannot entirely solve this loosening problem and require additional time in the assembly.

What is needed is a quick fastening method with a positive locking mechanism, with a means of removal that is not overly difficult. It is an object of the invention to provide such a method of connection.

### BRIEF SUMMARY OF THE INVENTION

This invention consists of a method for allowing the rapid and secure connection of two generally cylindrical parts, a central body that is traditionally a threaded cylinder, with a mating piece that is traditionally a nut. The improvement described allows a quick insertion of the nut replacement piece to the point of engagement and a partial turn engagement of the nut replacement with the modified central body, and a final latching of the engaged parts to prevent undesired release through vibration or creep. Accomplishment of the improvement is by the use of partial screw segments to allow insertion of the nut replacement axially over the central body without rotation until the nut replacement is positioned where a rotation of the nut replacement will engage partial screw threads, acting as perpendicular shoulders to limit relative axial movement of the two members. This use of partial screw segments further allows enhancements such as positive locking of an installed fastener, controlled operator release of the fastener, and controlled clamping action. After engagement of the partial screw segments, a mechanism is provided to lock the rotational movement, preventing any further rotational or axial relative movement of the two bodies.

The following discussion uses the attachment of a module to a panel by means of such an arrangement, but the advantage and the features of the coupling arrangement described are more general and applicable to a number of fastening situations, such as the attachment of a wheel to a hub, a closure to a container, seal to a pipe, and many other varied applications. In describing the preferred embodiment and the drawings, specific terminology will be resorted to for the sake of clarity. However, it is not intended that the invention be limited to the specific termso selected and it is to be understood that each specific term includes all technical equivalents that operate in a similar manner to accomplish a similar purpose. Those skilled in the art will recognize that there are many, and in the future may be additional, alternative implementations that are recognized as equivalent because they provide the same functional operation.

An interrupted screw is defined as “a screw with a slot or slots cut into the thread, especially one used in the breech of some guns permitting both engagement and release of the block by a partial turn of the screw” (The Collins English Dictionary© 2000 HarperCollins Publishers). The advantage of an interrupted screw is that a strong attachment can be made with this partial turn, and tolerances need not be more stringent than for a normal screw. For quick attachment of a module to a panel, for instance, the module body can have such an interrupted screw and the fastener has a matching thread pattern. The use of the fixed, partial turn of the fastener to fully engage the matching screw threads on the body allows the use of an alignment of the engaged screw thread shoulders to restrict the relative axial motion between the module and a fully engaged fastener, and a latching mechanism to prevent the relative radial movement thus keeping the fastener from disengaging. One implementation of this latching mechanism is a pawl and cog, to prevent the rotation of the body and fastener from unscrewing. A “pawl and cog” mechanism is defined as a lever arm (the pawl) with a face at the end that engages a protrusion or depression on the opposite member (the cog) to prevent further relative movement. This action provides a “snap” connection that positively locks the fastener and provides a more secure connection than a thread and nut.

Once the latching mechanism is engaged the fastener is prevented from unscrewing from the body. A method can be provided for the disengagement of the latching mechanism to allow easy unscrewing of the fastener form the body for module repair or replacement. In cases where removal of the module is to be prevented or made very difficult, the latching mechanism can be placed in an inaccessible location or can be only disengaged with a special tool.

The pitch of an ordinary interrupted screw provides a movement of the fastener axially along module body toward the panel. If this movement is not desired, the pitch of the screw threads can be made zero. There is often an advantage in allowing a yielding interface between the fastener and panel so that the tightening of the fastener against the body will force a compression of the yielding interface. This will increase the clamping force to the panel, which prevents the rotation of an installed module in the panel, avoids the appearance of loose components and prevents twisting of connecting wiring. The controlled tightening allows the reliable use of an elastometric seal to provide a water or gas tight seal.

### BRIEF DESCRIPTION OF THE SEVERAL VIEWS OF THE DRAWINGS

FIG. 1 is a drawing of a preferred embodiment of the invention utilizing a pawl and cog latch utilizing a separate groove as a latch.

FIG. 2 is a drawing of a preferred embodiment of the invention utilizing a pawl and cog latch utilizing the interrupted screw channel as the groove.

FIG. 3 is a drawing of a preferred embodiment of the invention utilizing a raised cog on the main body.

FIG. 4 is a drawing of a preferred embodiment of the invention utilizing a single thread.

FIG. 5 is a drawing of a preferred embodiment of the invention utilizing a interrupted screw with a pawl between the screw sections.

FIG. 6 is a drawing showing details of some particular pawl and cog implementations.

### DETAILED DESCRIPTION OF THE INVENTION

While the following discussion discusses the use of the fastening concept primarily as a means of attaching a module to a panel, the fastening process is equally adapted to most instances where traditionally a bolt and nut action has been used to accomplish the action of applying a fastener to a cylinder. Examples of such an action where this invention also has applicability is the attachment of a wheel to a hub, the attachment to studs mounted on a second body, and the attachment of two cylindrical bodies, one to another.

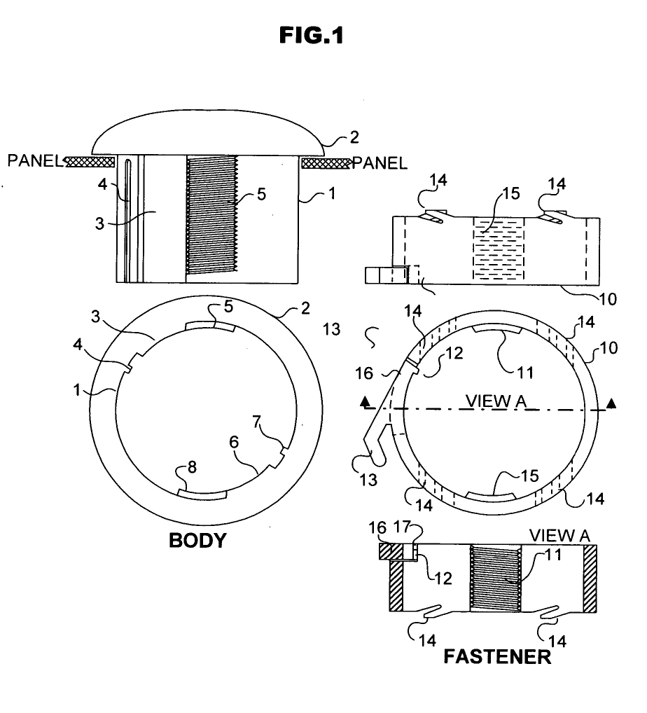

Directing attention to FIG. 1, a detailed drawing of a preferred embodiment is shown. There is a module body consisting of a head 2 and main body 1. The main body 1 is inserted through the panel as shown. There is a fastener 10 for mating with the main body 1. The main body 1 has a channel 3 and the fastener has a pawl 16 with a pawl face 12, and a section of screw 11. The channel 3 is wide enough to allow the screw section 11 to fit within the channel and allow insertion of the fastener 10 without interference. There is a matching channel 6 in main body 1 on the opposite side to allow passage of the threads 15 on the opposite side of fastener 10. When the fastener is inserted up around module body 1 against the panel, a clockwise turn will engage the body threads 5 and 8 with the fastener threads 11 and 15. Tightening the fastener 10 will compress the four compliant fittings 14 through the screw travel along the thread pitch. This will insure a tight fit. Alternatively, an elastometric ring attached under the lip of body top 2 can replace compliant fittings 14. This, together with the controlled compression provided by the interrupted screw, would allow a gas-tight seal at the panel.

The bottom of the fastener 10 contains pawl 16 with face 12. Face 12 is beveled on side 17 facing the panel. When fastener 10 is inserted over the panel as described previously, the pawl face 12 contacts the outside face of body 1 and is distended away from the axis. When the screw threads are completely engaged, the pawl face 12 will fall into groove 4 in the body and will be held in place by the distention force. This will latch the fastener in place and prevent the unscrewing of fastener 10 from body 1. The edge of groove 4 acts as the cog for pawl 16. Groove 7 is identical to groove 4 and is on the opposite side of main body 1 to allow equivalent operation if fastener 10 is rotated a half turn.

It is to be noted that the relative views of the body and fastener are shown as they would be related when the body and fastener are fully engaged and locked.

If it is desired to remove fastener 10, tab 13 attached to pawl 16 can be depressed, i.e. forced toward the axis of fastener 10. This will lever pawl face 12 out of groove 4 and allow turning of fastener 10. A short turn counter-clockwise will disengage the screw sections and allow removal of the fastener by extracting thread sections 11 and 15 through channels 3 and 6.

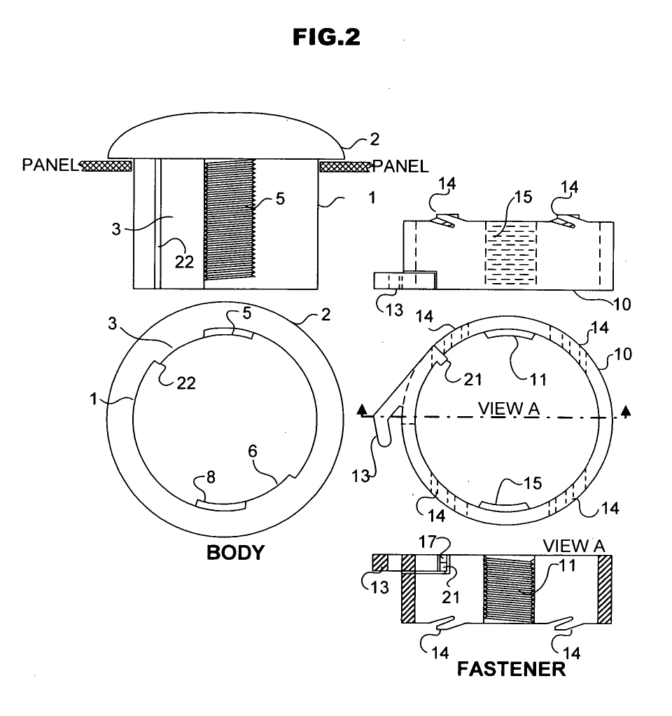

Another preferred embodiment is shown in FIG. 2. This embodiment uses the edge 22 of channel 3 of body 1 as the cog for pawl face 21. Pawl face 21 is beveled as before on the side toward the panel 17. When fastener 10 is inserted into main body 1, the bevel 17 contacts the outside of main body 1 and is distended away from the axis. When fastener 10 is completely attached to the body, screw segments 5 and 8 will be fully engaged with screw segments 11 and 15 as before. In this position pawl face 21 will fall over the edge 22 of channel 3 and be held in place by the distention force. Fastener 10 will then be locked in place and prevented from unscrewing. As before, depressing tab 13 will lever pawl face 21 out of engagement with edge 22 and will allow turning fastener 10 and the extraction of fastener 10.

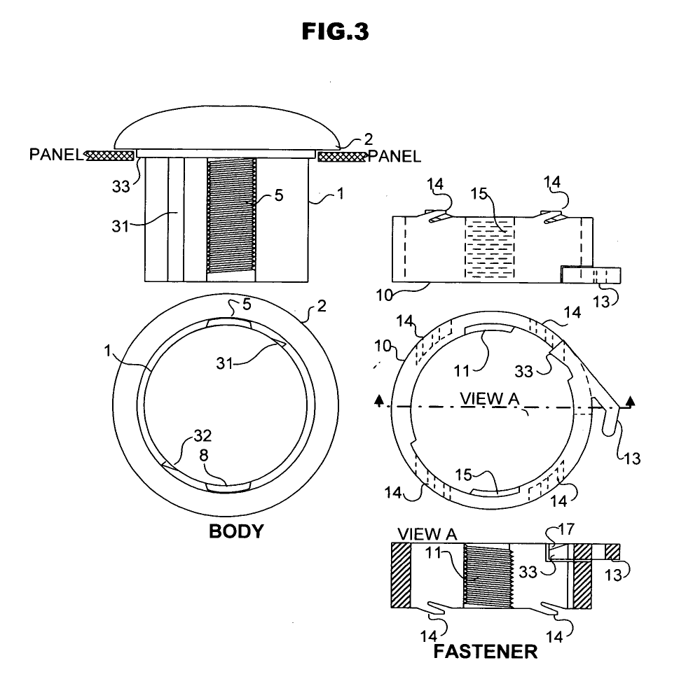

Another preferred embodiment is shown in FIG. 3. In this embodiment main body 1 contains only the screw segments 5 and 8 and cogs 31 and 32. When fastener 10 is inserted and closed as before, pawl face 33 will fall over cog 31 and will be prevented from unscrewing. As before, depressing tab 13 will lever pawl face 33 over cog 31 and allow unscrewing and extraction of the fastener.

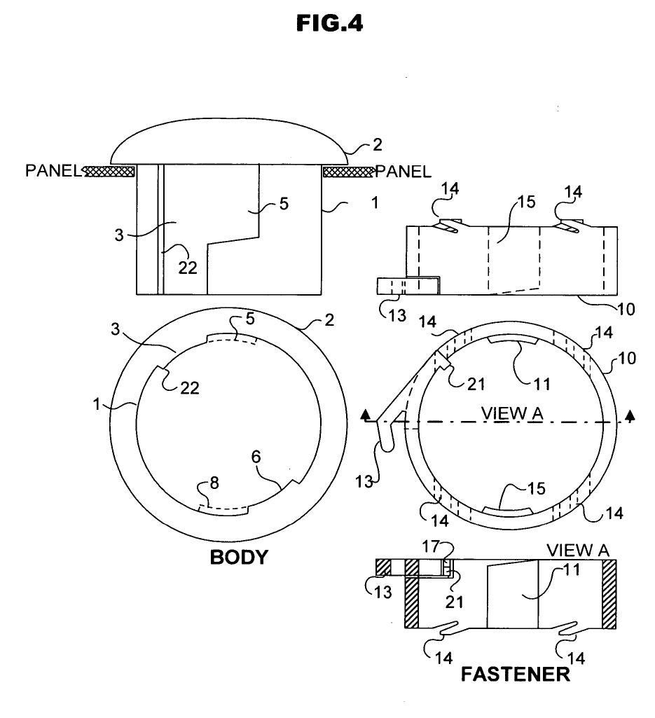

The simplest form of interrupted screw is a single partial screw thread. This is illustrated in FIG. 4. The threads 5, 8, 11 and 15 are reduced to a single surface at the bottom of the thread area. This configuration delivers the strongest clamping and precisely defined spacing when the unit is closed. It is useful when the panel thickness is fixed.

The compressible pads 14 can take many forms or, alternatively a compressible gasket between the body head 2 and the panel may replace their function. The restricted compression entailed in closing one portion of the thread pitch would insure a reliable seal for such a gasket. The screw threads in 5 and 8 and in 11 and 15 can have a pitch to compress pads 14 for a tight fit. Alternatively they can have no pitch and allow only fastener closing. While the use of two screw segments on each of the body and fastener is shown, the invention equally encompasses the use of more than two thread segments, or the use of a single screw segment. The use of a groove or extension as a cog in body 1 as shown in the previous examples need not be near the partial screw threads 5 or 8 but can be at any orientation on body 1 with a corresponding modification of the pawl. There are many other permutations of the latching pawl, as is obvious to those skilled in the art, and the embodiments illustrated are suggestive of other structures with equivalent functionality.

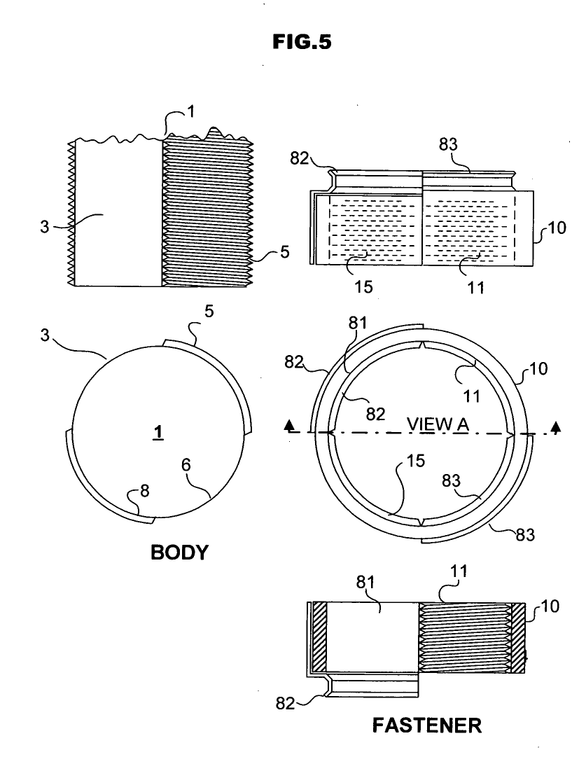

FIG. 5 illustrates a preferred embodiment utilizing a more traditional interrupted screw arrangement where the screw elements 5 and 8 are gripped by clamps 82 and 83 when the matching screw elements 11 and 15 in the fastener are fully engaged. The interrupted channel 81 is now large enough to allow the passage of the body threads 5 on first insertion. The top of clamp 82 also functions as a compliant shoulder as has been discussed previously.

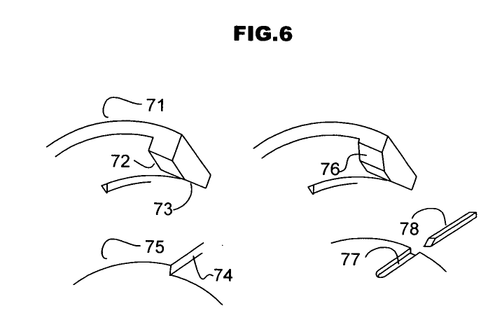

Referring to FIG. 6 the operation of the simple latching mechanism utilizing the pawl and cog principle is illustrated. Elements 71, 72 and 73 illustrate a simple pawl as was described on the fastener in FIG. 2. Elements 74 and 75 represent the body surface to which the catch is to mate. When the fastener is first inserted over the body the pawl face 73 will encounter the high side of body at 75. Since the pawl face 73 is beveled this will force the pawl away from the axis of the body so that initially face 72 rides on face 75. This distends the pawl body at 71 and will supply an axial force to face 72. When the fastener is rotated to engage the interrupted screw, face 72 will move toward the thread clearance slot edge 74. When the threads are fully engaged, face 72 will fall into the slot and pawl edge 72 will be held by 74 to prevent the unscrewing of the threads. Tab 13 in FIG. 2 is not shown but this would allow the raising of face 72 over the edge 74 and allow rotation of the fastener to disengage the threads. If the tab were not present this would make more difficult the removal of the fastener. The removal can be expedited for selective personnel by providing for a tool to release the pawl, as, for example, beveling the outside edge of the pawl as shown by element 76 and providing a wedge-shaped tool to lift the pawl as shown by element 78.

If the removal of the module is to be permanently discouraged, the catch can be hidden. For example, if the pawl is on the side of the fastener closest to the panel, and the slot is of limited length, as shown in element 77, and the pawl contains no removal tab, then release of the catch would be extremely difficult.

It should be appreciated by those skilled in the art that, while the illustrations show thread sections with a basic 180 degree symmetry, this is not an essential element of the proposed invention, and implementations with one thread section, with basic 120 degree symmetry (three thread sections) or 90 degree symmetry (four thread sections) or other multiples are also possible and are considered to be within the scope of this invention.

1. A connector joining two generally cylindrically-shaped pieces, comprising:
(a) a central piece; and
(b) one or more shoulders on an outward-facing surface of a portion of the circumference of said central piece; and
(c) an attachment piece; and
(d) one or more shoulders on an inward-facing surface of said attachment piece which can be aligned through rotational movement with said one or more shoulders on said central piece to prevent axial movement of said attachment piece relative to said central piece; and
(e) providing a means whereby said attachment piece can axially move relative to said central piece, and said axial movement positions said one or more said shoulders on said attachment piece with said one or more shoulders on said central piece to allow alignment of said shoulders by rotation of said attachment piece relative to said central piece; and
(f) providing a means whereby further forward rotational movement is prevented when said one or more shoulders on said central piece are in alignment with said one or more shoulders on said attachment piece, and whereby further backward rotational movement is prevented when said one or more shoulders on said central piece are in alignment with said one or more shoulders on said attachment piece,
whereby said attachment piece can be quickly positioned on said central piece by displacement in the axial direction, and can be securely attached by rotation into a latched position to prevent subsequent axial or rotational movement.

2. The connector joining two generally cylindrically-shaped pieces of claim 1 wherein:
(a) said one or more shoulders on an outward-facing surface of a portion of the circumference of said central piece consists of portions of a concave threaded surface; and
(b) said one or more shoulders on an inward-facing surface of said attachment piece consists of portions of a convex threaded surface.

3. The connector joining two generally cylindrically-shaped pieces of claim 1 wherein said means whereby said attachment piece can axially move relative to said central piece, and said axial movement positions said one or more said shoulders on said attachment piece with said one or more shoulders on said central piece to allow alignment of said shoulders by rotation of said attachment piece relative to said central piece comprises an interrupted screw mechanism.

4. The connector joining two generally cylindrically-shaped pieces of claim 1 further including:
(a) providing a means for a yielding interface between said central piece and said attachment piece whereby said alignment through rotational movement creates a seal to or stronger clamping to a surface between said central piece and said attachment piece.

5. The connector joining two generally cylindrically-shaped pieces of claim 1 wherein said means whereby further rotational movement is prevented comprises a pawl and groove mechanism between said attachment piece and said central piece.

6. The connector joining two generally cylindrically-shaped pieces of claim 1 further including:
(a) providing a means for the discretionary removal of said prevention of forward rotational movement and prevention of reverse rotational movement to allow rotational movement to effect the separation of said attachment piece from said central piece.

7. The method of providing a connection between two generally cylindrically-shaped pieces of claim 6 whereby said means for the discretionary removal of said prevention of forward rotational movement and prevention of reverse rotational movement comprises the use of a tool to release the rotation restriction mechanism.

8. A method of providing a connection between two generally cylindrically-shaped pieces, comprising:
(a) providing a central piece; and
(b) providing one or more shoulders on an outward-facing surface of a portion of the circumference of said central piece; and
(c) providing an attachment piece; and
(d) providing one or more shoulders on an inward-facing surface of said attachment piece which can be aligned through rotational movement with said one or more shoulders on said central piece to prevent axial movement of said attachment piece relative to said central piece; and
(e) providing a means whereby said attachment piece can axially move relative to said central piece, and said axial movement positions said one or more said shoulders on said attachment piece with said one or more shoulders on said central piece to allow alignment of said shoulders by rotation of said attachment piece relative to said central piece; and
(f) providing a means whereby further forward rotational movement is prevented when said one or more shoulders on said central piece are in alignment with said one or more shoulders on said attachment piece, and whereby further backward rotational movement is prevented when said one or more shoulders on said central piece are in alignment with said one or more shoulders on said attachment piece,
whereby said attachment piece can be quickly positioned on said central piece by displacement in the axial direction, and can be securely attached by rotation into a latched position to prevent subsequent axial or rotational movement.

9. The method of providing a connection between two generally cylindrically-shaped pieces of claim 8 wherein:
(a) said one or more shoulders on an outward-facing surface of a portion of the circumference of said central piece consists of portions of a concave threaded surface; and
(b) said one or more shoulders on an inward-facing surface of said attachment piece consists of portions of a convex threaded surface.

10. The method of providing a connection between two generally cylindrically-shaped pieces of claim 8 wherein said means whereby said attachment piece can axially move relative to said central piece, and said axial movement positions said one or more said shoulders on said attachment piece with said one or more shoulders on said central piece to allow alignment of said shoulders by rotation of said attachment piece relative to said central piece comprises an interrupted screw mechanism.

11. The method of providing a connection between two generally cylindrically-shaped pieces of claim 8 further including:
(a) providing a means for a yielding interface between said central piece and said attachment piece whereby said alignment through rotational movement creates a seal to or stronger clamping to a surface between said central piece and said attachment piece.

12. The method of providing a connection between two generally cylindrically-shaped pieces of claim 8 wherein said means whereby further rotational movement is prevented comprises a pawl and groove mechanism between said attachment piece and said central piece.

13. The method of providing a connection between two generally cylindrically-shaped pieces of claim 8 further including:
(a) providing a means for the discretionary removal of said prevention of forward rotational movement and prevention of reverse rotational movement to allow rotational movement to effect the separation of said attachment piece from said central piece.

14. The method of providing a connection between two generally cylindrically-shaped pieces of claim 13 whereby said means for the discretionary removal of said prevention of forward rotational movement and prevention of reverse rotational movement comprises the use of a tool to release the rotation restriction mechanism.
